(19) United States
(12) Patent Application Publication
(10) Pub. No.: US 2017/0242426 A1
(43) Pub. Date: Aug. 24, 2017

(54) QUALITY MANAGEMENT APPARATUS, QUALITY MANAGEMENT METHOD, AND NON-TRANSITORY COMPUTER READABLE MEDIUM

(71) Applicant: FUJI XEROX CO., LTD., Tokyo (JP)

(72) Inventors: Kaoru YASUKAWA, Kanagawa (JP); Masayasu TAKANO, Kanagawa (JP); Shoji YAMAGUCHI, Kanagawa (JP); Yuki KATADA, Kanagawa (JP)

(73) Assignee: FUJI XEROX CO., LTD., Tokyo (JP)

(21) Appl. No.: 15/222,466

(22) Filed: Jul. 28, 2016

(30) Foreign Application Priority Data
Feb. 19, 2016 (JP) 2016-029983

(51) Int. Cl. G05B 23/02; G06F 17/30; G07C 5/08; B62D 65/00

(52) U.S. Cl. CPC G05B 23/024; B62D 65/005; G06F 17/30595; G07C 5/0816; G05B 2219/31357

(57) ABSTRACT

A quality management apparatus includes an acquisition unit and an extraction unit. The acquisition unit acquires, about products to be managed, a rate of occurrence of a malfunction on an occurrence period basis, an operation condition of the products, and a manufacturing condition for the products. The extraction unit classifies the rate of occurrence into layers under the operation condition, and extracts, for each layer under the operation condition, a relationship between the rate of occurrence and the manufacturing condition.

### CROSS-REFERENCE TO RELATED APPLICATIONS

This application is based on and claims priority under 35 USC 119 from Japanese Patent Application No. 2016-029983 filed Feb. 19, 2016.

### BACKGROUND

### Technical Field

The present invention relates to a quality management apparatus, a quality management method, and a non-transitory computer readable medium.

### SUMMARY

According to an aspect of the invention, there is provided a quality management apparatus including an acquisition unit and an extraction unit. The acquisition unit acquires, about products to be managed, a rate of occurrence of a malfunction on an occurrence period basis, an operation condition of the products, and a manufacturing condition for the products. The extraction unit classifies the rate of occurrence into layers under the operation condition, and extracts, for each layer under the operation condition, a relationship between the rate of occurrence and the manufacturing condition.

### BRIEF DESCRIPTION OF THE DRAWINGS

An exemplary embodiment of the present invention will be described in detail based on the following figures, wherein:

FIG. 1 is a block diagram illustrating an example of the entire configuration of a quality management system;

FIG. 2 is a block diagram illustrating a functional configuration of a quality management apparatus according to an exemplary embodiment;

FIG. 3A is a table illustrating an example of a time-series distribution of the rate of occurrence of a malfunction in a layer having a mileage of 0 to 3000 km according to the exemplary embodiment;

FIG. 3B is a table illustrating an example of a time-series distribution of the rate of occurrence of the malfunction in a layer having a mileage of 3000 to 6000 km according to the exemplary embodiment;

FIG. 3C is a table illustrating an example of a time-series distribution of the rate of occurrence of the malfunction in a layer having a mileage of 6000 to 9000 km according to the exemplary embodiment;

FIG. 3D is a table illustrating an example of a time-series distribution of the rate of occurrence of the malfunction in a layer having a mileage of 9000 to 12000 km according to the exemplary embodiment;

FIG. 4 is a schematic diagram illustrating an example of malfunction information according to the exemplary embodiment;

FIG. 5A is a schematic diagram illustrating an example of a time-series distribution of the activity ratio of a part according to the exemplary embodiment;

FIG. 5B is a schematic diagram illustrating an example of a time-series distribution of the activity ratio of a part according to the exemplary embodiment;

FIG. 6 is a schematic diagram illustrating an example of a time-series distribution of the activity ratio of a part, for operators who have manufactured the part, on an operator basis according to the exemplary embodiment;

FIG. 7 is a schematic diagram illustrating an example of malfunction-related information according to the exemplary embodiment;

FIG. 8 is a schematic diagram illustrating an example of malfunction-related information according to the exemplary embodiment;

FIG. 9 is a schematic diagram illustrating an example of specific malfunction-related information according to the exemplary embodiment;

FIG. 10 is a graph illustrating an example of a failure rate bathtub curve derived from data regarding the lifetime of a part;

FIG. 11 is a graph illustrating an example of a method according to the exemplary embodiment for classifying the rate of occurrence of a malfunction into layers under an operation condition;

FIG. 12 is a block diagram illustrating an electrical configuration of a quality management apparatus according to the exemplary embodiment;

FIG. 13 is a flowchart illustrating a quality management processing program according to the exemplary embodiment; and

FIG. 14 is a graph illustrating an example of a method according to the exemplary embodiment for classifying the rate of occurrence of a malfunction into layers under two types of operation condition.

### DETAILED DESCRIPTION

In the following, a quality management apparatus according to the present exemplary embodiment will be described with reference to the attached drawings. Note that, in the present exemplary embodiment, a case will be described where the quality management apparatus according to the exemplary embodiment of the present invention is applied to a quality management system in which vehicles on the market are treated as quality management targets.

First, the quality management system will be described in detail.

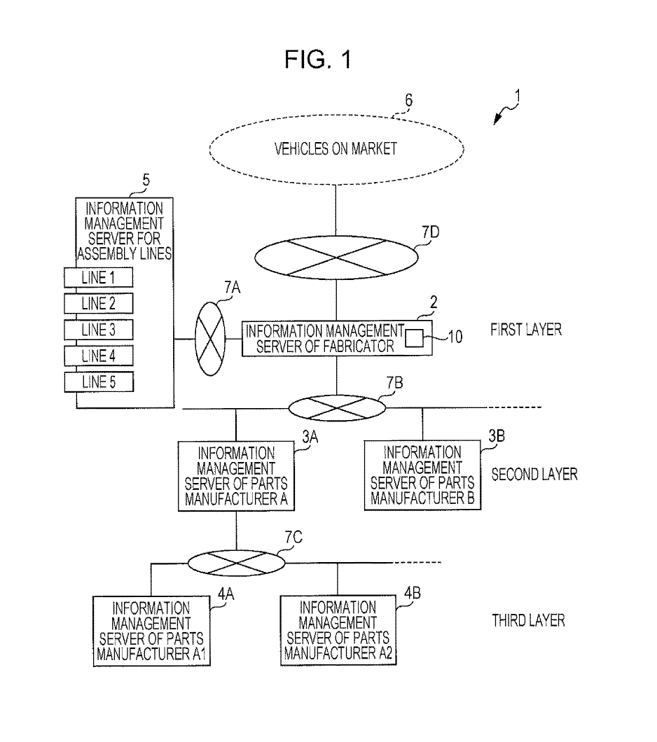

As an example as illustrated in FIG. 1, a quality management system 1 is formed by connecting multiple information management servers 2, 3A, 3B, 4A, and 4B via communication networks 7A, 7B, 7C, and 7D in for example a three-layer configuration. The information management server 2 of a fabricator is provided at a node of a first layer, which is the highest layer. The information management server 3A of a parts manufacturer A and the information management server 3B of a parts manufacturer B are provided at nodes of a second layer, which is lower than the first layer, the parts manufacturer A and the parts manufacturer B supplying parts to the fabricator. Furthermore, the information management server 4A of a parts manufacturer A1 and also the information management server 4B of a parts manufacturer A2 are provided at nodes of a third layer, which is lower than the second layer, the parts manufacturer A1 and the parts manufacturer A2 supplying parts to the parts manufacturer A.

In addition, the information management server 2 of the fabricator is connected, via the communication network 7A, to an information management server 5 for assembly lines where an assembly operation is performed. In addition, the information management server 2 of the fabricator is connected to the information management server 3A of the parts manufacturer A and the information management server 3B of the parts manufacturer B via the communication network 7B. In addition, the information management server 3A of the parts manufacturer A is connected to the information management server 4A of the parts manufacturer A1 and the information management server 4B of the parts manufacturer A2 via the communication network 7C.

The information management server 2 of the fabricator acquires, from the information management servers 3A and 3B of the parts manufacturers A and B, information regarding supplied parts and information regarding malfunctions of the supplied parts. In addition, the information management server 2 of the fabricator acquires, from the information management server 5 for the assembly lines, parts information regarding parts constituting an assembled product, and information regarding a malfunction of the parts constituting the products assembled in the assembly lines. The information management server 2 of the fabricator manages the acquired pieces of information as assembled-product manufacturing information.

Note that parts information is information regarding, for example, parts or part units that constitute a product, parts manufacturing conditions (for example, materials used to manufacture the parts), companies that have manufactured the parts, manufacturing lines used for manufacture of the parts, manufacturing factories for the parts, facilities used to manufacture the parts, and workers who have manufactured the parts.

In contrast, the information management server 2 of the fabricator is connected to vehicles 6 that are on the market via the communication network 7D. The information management server 2 of the fabricator then acquires, from the vehicles 6, information regarding malfunctions occurring in the vehicles 6 and information regarding operation conditions of the vehicles 6, and manages the quality of the vehicles 6 that are on the market in accordance with the acquired information.

Next, the configuration of a quality management apparatus 10 according to the present exemplary embodiment will be described in detail. Note that the case where the quality management apparatus 10 is provided at the information management server 2 of the fabricator will be described in the present exemplary embodiment; however, the place where the quality management apparatus 10 is provided is not limited to this case. For example, the quality management apparatus 10 may be provided separately from the information management servers 2, 3A, 3B, 4A, and 4B illustrated in FIG. 1, and may also acquire pieces of information from each of the information management servers 2, 3A, 3B, 4A, and 4B.

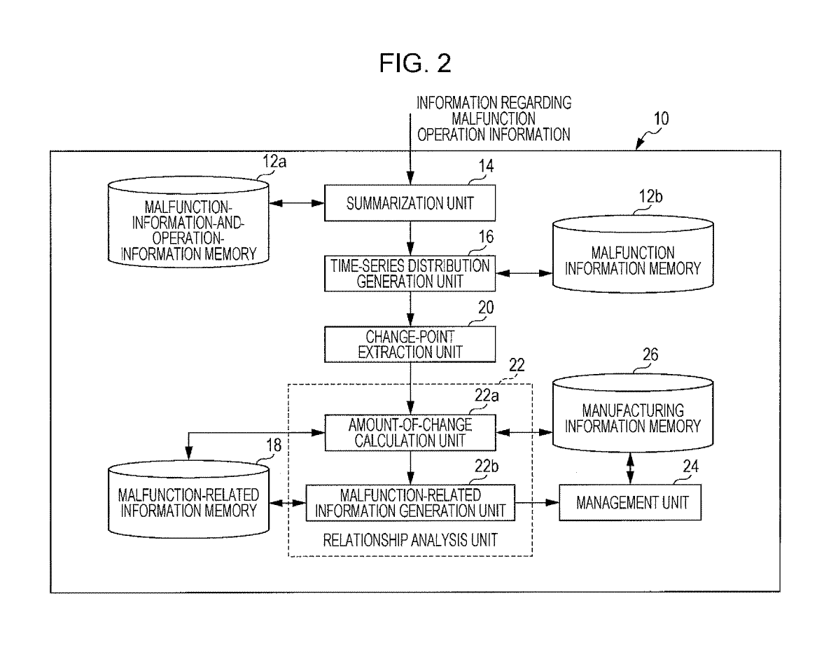

As illustrated in FIG. 2, the quality management apparatus 10 has a malfunction-information-and-operation-information memory 12a, a malfunction information memory 12b, a summarization unit 14, a time-series distribution generation unit 16, a malfunction-related information memory 18, a relationship analysis unit 22, a management unit 24, and a manufacturing information memory 26. In addition, the relationship analysis unit 22 has an amount-of-change calculation unit 22a and a malfunction-related information generation unit 22b.

The summarization unit 14 acquires, from the vehicles 6 that are on the market, information regarding malfunctions occurring in the vehicles 6, and classifies, into types, the malfunctions from the acquired information. The case where when a malfunction occurs in a vehicle 6 among the vehicles 6, the vehicle 6 transmits information regarding the malfunction to the quality management apparatus 10 will be described in the present exemplary embodiment; however, the timing of transmission of a malfunction is not limited to this case. For example, each of the vehicles 6 may determine whether a malfunction has occurred every time a predetermined time (for example, 24 hours) has passed, and may transmit information regarding the malfunction in the case of occurrence of the malfunction. Alternatively, in the case where a malfunction has occurred in a vehicle 6 among the vehicles 6, a user may input, to the quality management apparatus 10, information regarding the malfunction using an operation input unit 40, which will be described later.

In addition, for malfunctions, an identification number is assigned on a malfunction-type basis in the present exemplary embodiment. In information regarding a malfunction, the type of the malfunction is indicated by an identification number. In the present exemplary embodiment, malfunctions are classified into types on the basis of identification numbers included in information regarding the malfunctions. However, a method for classifying malfunctions into types is not limited to this. For example, the type of a malfunction that has occurred may also be attached, as a character string, to information regarding the malfunction. In this case, for example, the malfunction is classified into a certain type on the basis of a keyword acquired by performing a keyword search using the attached character string or the like.

In addition, the summarization unit 14 acquires, from each of the vehicles 6 on the market, information regarding a malfunction, and also information indicating the type (vehicle model) of the vehicle 6 in which the malfunction has occurred, and operation information indicating an operation condition of the vehicle 6 in which the malfunction has occurred. The summarization unit 14 then stores, in the malfunction-information-and-operation-information memory 12a, the type of the malfunction, the type of the vehicle 6, and the operation condition in association with a period in which the malfunction has occurred.

Note that the mileage of the vehicle 6 (the total travel distance after the vehicle 6 is manufactured) is used as the operation condition in the present exemplary embodiment. However, the operation condition is not limited to the mileage, and may be for example the number of times the engine is switched on and off, the average speed of the vehicle 6 when the vehicle 6 is driving, or the average temperature around the vehicle 6.

In the case where the summarization unit 14 has acquired information regarding a malfunction, the summarization unit 14 acquires, from the malfunction-information-and-operation-information memory 12a, information indicating the type of malfunction, the type of vehicle 6, an operation condition, and a period in which the malfunction has occurred, and outputs the acquired pieces of information to the time-series distribution generation unit 16. Note that the acquired pieces of information may be information acquired for all types of malfunction, or may also be information acquired for a specific type of malfunction. In addition, the timing at which the summarization unit 14 outputs the above-described pieces of information is not limited to a timing corresponding to the case where the summarization unit 14 has acquired the information regarding the malfunction, and may also be a timing corresponding to the case where the summarization unit 14 has acquired request information from the time-series distribution generation unit 16 or may also be a timing every time a predetermined time has elapsed.

When the time-series distribution generation unit 16 receives, from the summarization unit 14, information regarding the type of malfunction, the type of vehicle 6, an operation condition, and a period in which a malfunction has occurred, the time-series distribution generation unit 16 generates a time-series distribution diagram illustrating the rate of occurrence of the malfunction on the basis of the received information. In this case, information regarding the malfunction is classified into layers on a mileage-range basis in the present exemplary embodiment, the mileage being the operation condition, and a time-series distribution diagram illustrating the rate of occurrence of the malfunction is generated for each type of malfunction. Note that the rate of occurrence of a malfunction is the ratio of the number of vehicles 6 in which the malfunction has occurred to the number of vehicles 6 operating on the market in the present exemplary embodiment.

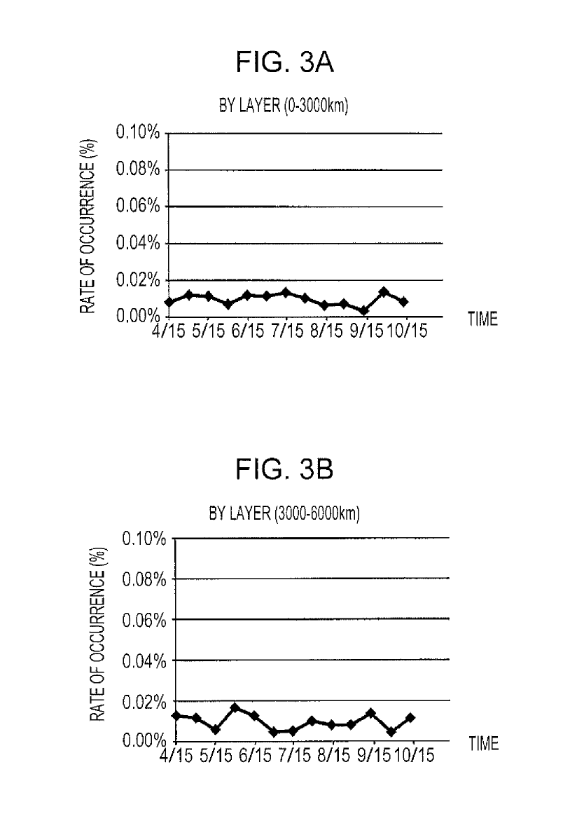

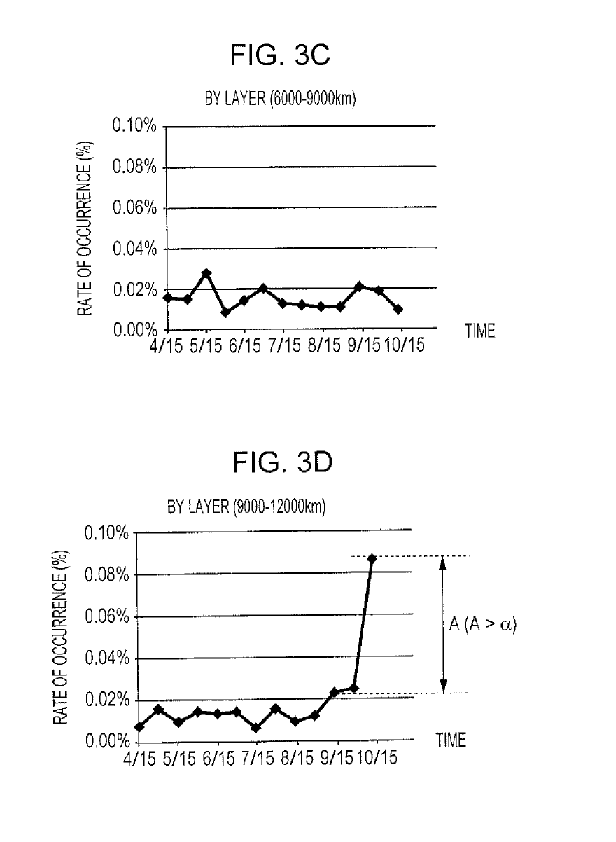

As an example, FIGS. 3A to 3D illustrate time-series distribution diagrams each illustrating the rate of occurrence of a malfunction A. In the present exemplary embodiment, the rate of occurrence of the malfunction A is summarized every half month, the rate of occurrence of the malfunction A is classified into layers under the operation condition (the mileage), and a time-series distribution diagram is generated for each layer. Note that in each time-series distribution diagram illustrating the rate of occurrence of the malfunction A, the horizontal axis represents elapsed time, and the vertical axis represents the rate of occurrence of the malfunction A. In addition, the rate of occurrence of the malfunction A is summarized every half month in the present exemplary embodiment; however, the interval for summarization is not limited to this, and the rate of occurrence of the malfunction may also be summarized at any timing such as every certain time, every day, every week, or every month.

FIG. 3A illustrates a time-series distribution of the rate of occurrence of the malfunction A in vehicles 6 whose mileage is 0 to 3000 km, and FIG. 3B illustrates a time-series distribution of the rate of occurrence of the malfunction A in vehicles 6 whose mileage is 3000 to 6000 km. FIG. 3C illustrates a time-series distribution of the rate of occurrence of the malfunction A in vehicles 6 whose mileage is 6000 to 9000 km, and FIG. 3D illustrates a time-series distribution of the rate of occurrence of the malfunction A in vehicles 6 whose mileage is 9000 to 12000 km.

A change-point extraction unit 20 extracts change points of the rate of occurrence of a malfunction from a time-series distribution diagram of the rate of occurrence of the malfunction, the time-series distribution diagram being generated by the time-series distribution generation unit 16.

In the present exemplary embodiment, a change point of the rate of occurrence of the malfunction A is a point at which the amount of change in the rate of occurrence of the malfunction A in a predetermined period (for example, 30 days) is greater than or equal to a predetermined threshold (for example, 0.04%), which is an example of a first threshold. Note that a change point of the rate of occurrence of the malfunction A is not limited to this, and may also be a point at which the rate of occurrence of the malfunction A becomes the highest value (for example, 0.05%) allowable as the rate of occurrence of the malfunction A. In addition, the change point of the rate of occurrence of the malfunction A is expressed as a range having a predetermined size (for example, 30 days) with this change point as, for example, a median value. Note that, at the change point of the rate of occurrence of the malfunction A, it is estimated that the rate of occurrence of the malfunction A is increasing, in the period of this change point due to some reason such as a change made to a specific manufacturing condition.

Here, a method for extracting a change point of the rate of occurrence of a malfunction will be described using the time-series distribution diagrams of the rate of occurrence of the malfunction A illustrated in FIGS. 3A to 3D. For example, the rate of occurrence of the malfunction A is almost constant in the time-series distribution diagrams of the rate of occurrence of the malfunction A illustrated in FIGS. 3A to 3C. In contrast, in the time-series distribution diagram illustrated in FIG. 3D, suppose that the amount of change A in the rate of occurrence of the malfunction A from “September 15” to “October 15” is greater than the predetermined threshold α for the rate of occurrence of the malfunction A. In this case, for the vehicles 6 whose mileage is 9000 to 12000 km, it is estimated that the rate of occurrence of the malfunction A has increased between September 15 and October 15 because of some kind of change added to a manufacturing condition. In this case, a change point of the rate of occurrence of the malfunction A is extracted as “September 15 to October 15”.

When the change-point extraction unit 20 extracts a change point of the rate of occurrence of a malfunction, the amount-of-change calculation unit 22a calculates, for each manufacturing line, the amount of change in the activity ratio of a part at the extracted change point. Note that, for parts manufactured under predetermined manufacturing conditions, the activity ratio of each part represents the ratio of the number of vehicles 6 including the part to the number of vehicles 6 in which the malfunction has occurred in the present exemplary embodiment. In addition, the activity ratio of each part is calculated at a change point in the present exemplary embodiment; however, what is calculated is not limited to this, and the amount of change in the activity ratio of each part may also be calculated in a range including and wider than this change point. As a result, in the case where the amount of change in the rate of occurrence of the malfunction on a time-series basis becomes greater than or equal to the threshold α, and the amount of change in the activity ratio of a part becomes greater than or equal to a predetermined threshold β, which is an example of a second threshold, within a predetermined time period, this part is extracted as a part related to the malfunction of products.

First, the amount-of-change calculation unit 22a acquires malfunction information from the malfunction information memory 12b, and generates a time-series distribution diagram of the activity ratio of the part related to the malfunction.

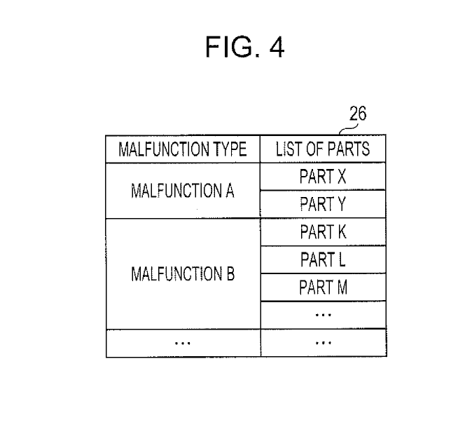

The malfunction information is, as an example as illustrated in FIG. 4, information in which each type of malfunction is associated with a list of parts related to the malfunction. According to the malfunction information illustrated in FIG. 4, it is clear that the parts related to the malfunction A are a part X and a part Y. Thus, the amount-of-change calculation unit 22a acquires a list of the parts related to the malfunction A (the part X and the part Y) from the malfunction information.

In contrast, the manufacturing information memory 26 stores the above-described manufacturing information. When acquiring the list of the parts related to the malfunction A (the part X and the part Y), the amount-of-change calculation unit 22a acquires, from the manufacturing information memory 26, information indicating the manufacturing conditions of the part X and the part Y. In addition, under each of the manufacturing conditions of the part X and the part Y, the amount-of-change calculation unit 22a generates a time-series distribution diagram of the activity ratio on a part basis.

Note that a manufacturing line where a part is manufactured (also referred to as “lot”) is used as a manufacturing condition to generate a time-series distribution diagram of the activity ratio of the part in the present exemplary embodiment.

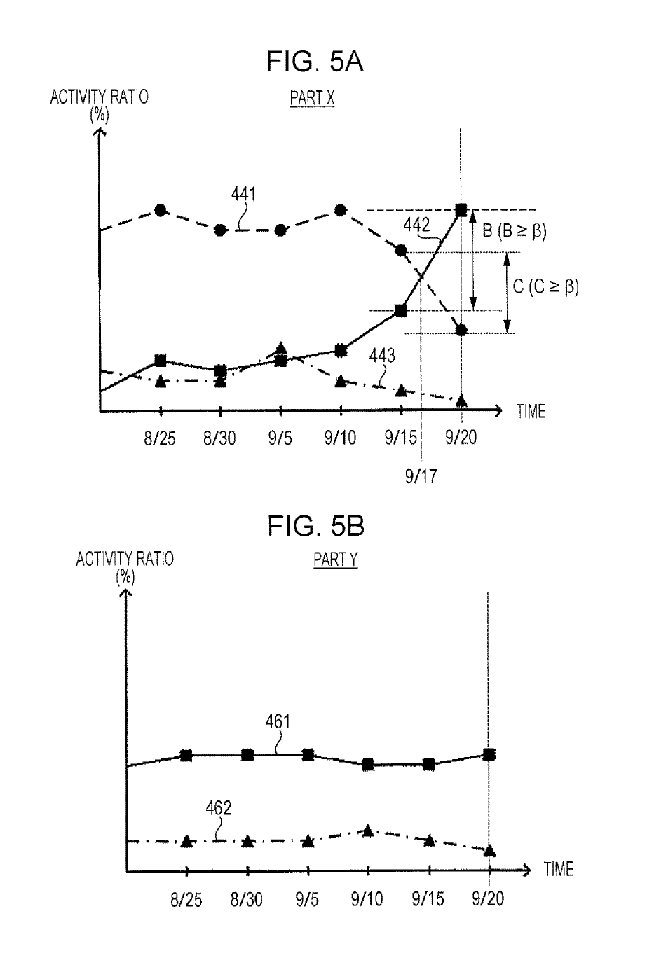

FIG. 5A illustrates as an example a time-series distribution diagram of the activity ratio of the part X on a manufacturing line basis, and FIG. 5B illustrates as an example a time-series distribution diagram of the activity ratio of the part Y on a lot basis. In FIG. 5A, the activity ratio of parts X manufactured in a lot X1 is denoted by 441, the activity ratio of parts X manufactured in a lot X2 is denoted by 442, and the activity ratio of parts X manufactured in a lot X3 is denoted by 443. In addition, in FIG. 5B, the activity ratio of parts Y manufactured in a lot Y1 is denoted by 461, and the activity ratio of parts Y manufactured in a lot Y2 is denoted by 462. That is, it is clear that the parts X are manufactured in three manufacturing lines (the lot X1, the lot X2, and the lot X3) according to the time-series distribution diagram illustrated in FIG. 5A, and the parts Y are manufactured in two manufacturing lines (the lot Y1 and the lot Y2) according to the time-series distribution diagram illustrated in FIG. 5B.

For the activity ratio of the part X, at the time of “September 15”, the activity ratio 441 of the parts X manufactured in the lot X1 is higher than the activity ratios 442 and 443 of the parts X manufactured in the lot X2 and the lot X3. However, at the time of “September 17”, the activity ratio 441 of the parts x manufactured in the lot X1 and the activity ratio 442 of the parts X manufactured in the lot X2 become equal. Furthermore, at the time of “September 20”, the activity ratio 442 of the parts X manufactured in the lot X2 is higher than the activity ratio 441 of the parts X manufactured in the lot X1. In contrast, the activity ratio 443 of the parts X manufactured in the lot X3 indicates that the activity ratio 443 at the time of “September 20” is slightly decreasing with respect to that at the time of “September 15”.

In the time-series distribution diagram of the activity ratio of the part x illustrated in FIG. 5A, the amount of change B in the activity ratio 442 of the parts X manufactured in the lot X2 from September 15 to September 20 is greater than or equal to the predetermined threshold β (for example, 20%). In addition, in the time-series distribution diagram of the activity ratio 441 of the part X illustrated in FIG. 5A, the amount of change C in the activity ratio 441 of the parts X manufactured in the lot X1 from September 15 to September 20 is greater than or equal to the threshold β.

In addition, in the time-series distribution diagram of the activity ratio of the part Y illustrated in FIG. 53, it is clear that the activity ratio 461 of the parts Y manufactured in the lot Y1 and the activity ratio 462 of the parts Y manufactured in the lot Y2 are almost constant although there are slight changes.

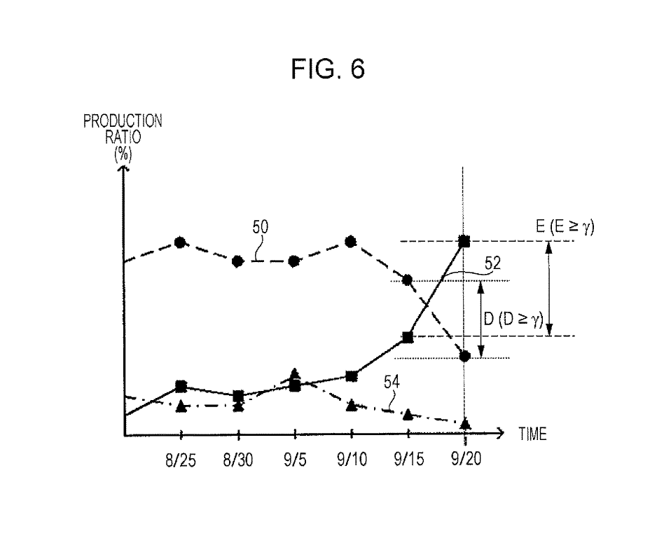

Note that the case where a time-series distribution diagram of the activity ratio of a certain part is generated on a manufacturing line basis has been described using FIGS. 5A and 5B; however, the way in which a time-series distribution diagram of the activity ratio of a certain part is generated is not limited to this case, and a time-series distribution diagram of the activity ratio of a certain part may also be generated on a worker basis, the workers being involved in the manufacture of the part. In that case, as an example as illustrated in FIG. 6, change points are extracted using a diagram in which part production ratios are distributed on a time-series basis and on a worker basis.

In the time-series distribution diagram of the part production ratios illustrated in FIG. 6, a production ratio 50 of a worker A, a production ratio 52 of a worker B, and a production ratio 54 of a worker C are almost constant from August 25 to September 10. However, the production ratio 52 of the worker B starts increasing from September 10 at a rate greater than or equal to a predetermined rate regarding increase. In addition, in the time-series distribution diagram of the part production ratios illustrated in FIG. 6, the amount of change D in the production ratio 50 of the worker A from September 10 to September 20 is greater than or equal to a predetermined threshold γ (for example, 20%), which is another example of the second threshold. In contrast, the amount of change E in the production ratio 52 of the worker B from September 10 to September 20 is greater than or equal to the threshold γ in the time-series distribution diagram of the part production ratios illustrated in FIG. 6. In such a case, “September 10 to September 20” is extracted as a change point for the part production ratios, the change point serving as a change point for a part manufacturing condition.

The malfunction-related information generation unit 22b generates malfunction-related information in which information regarding an extracted change point and information regarding the amount of change in the activity ratio of a certain part at the extracted change point are associated with each other on a manufacturing line basis. In addition, the malfunction-related information generation unit 22b stores, in the malfunction-related information memory 18, the generated malfunction-related information. Note that, even for a manufacturing line for which any change point is not extracted by the change-point extraction unit 20, that is, a manufacturing line for which no change point is present in the activity ratio of the part, the malfunction-related information generation unit 22b calculates the amount of change in the activity ratio of the part at a change point for another manufacturing line, and adds the resulting amount of change to the malfunction-related information.

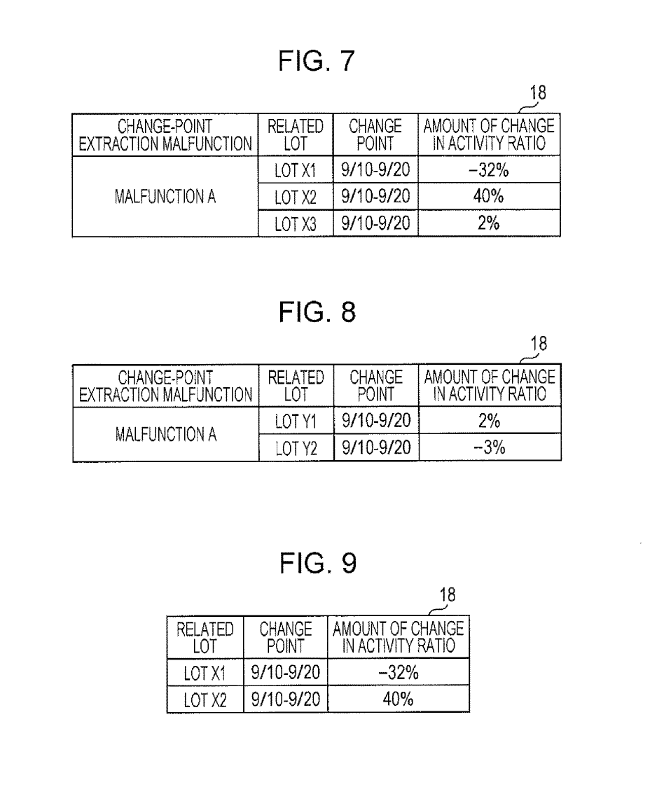

As an example as illustrated in FIG. 7, in malfunction-related information, the malfunction A is associated with the amounts of change in the activity ratio of the part X in the respective manufacturing lines (the lots X1 to X3) for parts X related to the malfunction A. The example illustrated in FIG. 7 indicates that the activity ratio of the part X increases at a rate of “−32%” at a change point for the parts X manufactured in the lot X1, and the activity ratio of the part X increases at a rate of “40%” at a change point for the parts X manufactured in the lot X2. In addition, the example illustrated in FIG. 7 indicates that the activity ratio of the part X for the parts X manufactured in the lot X3 increases at a rate of “2%” at the above-described change point.

In addition, as an example as illustrated in FIG. 8, in malfunction-related information, the malfunction A is associated with the amounts of change in the activity ratio of the part Y in the respective manufacturing lines (the lots Y1 and Y2) for parts Y related to the malfunction A. The example illustrated in FIG. 8 indicates that the activity ratio of the part Y for the parts Y manufactured in the lot Y1 increases at a rate of “+2%” at the above-described change point, and the activity ratio of the part Y for the parts Y manufactured in the lot Y2 increases at a rate of “−3%” at the above-described change point.

In addition, the malfunction-related information generation unit 22b generates specific malfunction-related information indicating a part for which the amount of change in the activity ratio of the part is greater than or equal to a predetermined threshold at a change point (from September 15 to October 15) of the rate of occurrence of the malfunction. That is, the specific malfunction-related information is generated so as to include only parts estimated to be parts related to the malfunction among the parts included in the malfunction-related information. The specific malfunction-related information is, as an example as illustrated in FIG. 9, information about manufacturing lines (the lots X1 and X2) for which the amount of change in the activity ratio of a part is greater than or equal to a predetermined threshold (for example, 20%) at the change point (from September 15 to September 20) of the activity ratio of the part, the information being extracted from the malfunction-related information. Note that since the activity ratio of the parts X manufactured in the lot X1 decreases, and the activity ratio of the parts X manufactured in the lot X2 increases at the above-described change point in the example illustrated in FIG. 9, the parts X manufactured in the lot X2 are specified as parts related to the malfunction of vehicles 6.

When the malfunction-related information generation unit 22b generates the specific malfunction-related information, the malfunction-related information generation unit 22b outputs the generated specific malfunction-related information to the management unit 24.

Note that the malfunction-related information generation unit 22b may also store, in the malfunction-related information memory 18, the generated specific malfunction-related information.

When the management unit 24 receives the specific malfunction-related information from the malfunction-related information generation unit 22b, the management unit 24 specifies the lot X1, which is the manufacturing line indicated by the malfunction information, and the parts manufacturer that has the lot X. In addition, the management unit 24 transmits the specific malfunction-related information to an information management server of the specified parts manufacturer.

Note that, in the case where parts manufactured by a parts manufacturer in a lower layer are related to the malfunction in accordance with the received malfunction-related information, the information management server of the parts manufacturer that has received the specific malfunction-related information transmits the specific malfunction-related information to the parts manufacturer in the lower layer.

For example, suppose that the parts manufacturer A for the part X manufactures parts X using parts a manufactured by the parts manufacturer A1 and parts b manufactured by the parts manufacturer A2. In this case, when the information management server 3A of the parts manufacturer A receives malfunction-related information from the information management server 2 of the fabricator, the parts manufacturer A specifies a part that has caused the malfunction, a manufacturing line used for manufacture of the part, and a parts manufacturer that has the manufacturing line.

Here, in the case where a part a is specified as a part related to the malfunction, the information management server 3A of the parts manufacturer A transmits the malfunction-related information to the information management server 4A of the parts manufacturer A1 that manufactures parts a. Even when manufacturing lines for manufacturing parts a are held by multiple parts manufacturers, the parts manufacturer that has manufactured the part a related to the malfunction is specified by information regarding the manufacturing line used for manufacture of the part a.

In this manner, the quality management apparatus 10 according to the present exemplary embodiment acquires, about products to be managed, the rate of occurrence of a malfunction on an occurrence period basis, an operation condition, and a manufacturing condition. In addition, the quality management apparatus 10 according to the present exemplary embodiment classifies the rate of occurrence of the malfunction into layers under the operation condition, and extracts, for each layer under the operation condition, a relationship between the rate of occurrence of the malfunction and the manufacturing condition.

Note that in the case where an operation time t is used as an operation conditions, and information regarding a malfunction is summarized, as the operation time t becomes longer, the degree to which the failure rate λ(t) of a product relies on the operation time t becomes higher. Note that the failure rate λ(t) is expressed as in the following (1) when a shape parameter is denoted by m, and a scale parameter is denoted by η.

[Math 1]

$$λ ( t ) = \frac{m}{η} \cdot {( \frac{t}{η} )}^{m - 1} \qquad ( 1 )$$

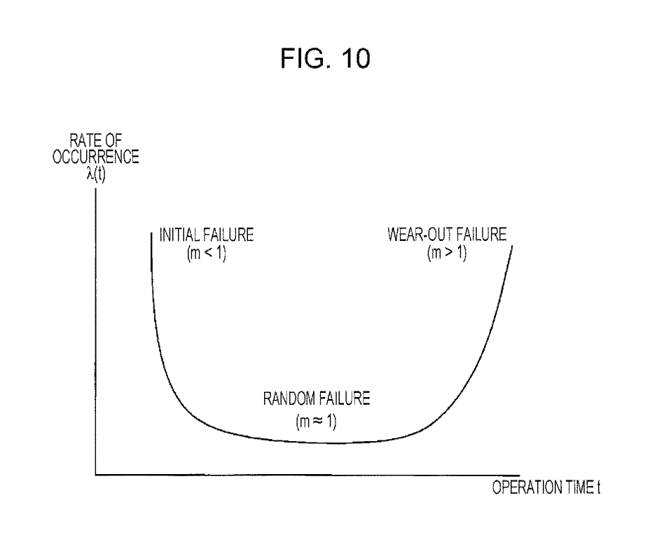

Here, an example of a failure rate bathtub curve derived from data regarding the lifetime of a part is illustrated in FIG. 10. As an example as illustrated in FIG. 10, the degree to which the failure rate λ(t) of the part relies on the operation time t is low (shape parameter m<1) in a period when the operation time t is short, and many initial failures occur. In contrast, the degree to which the failure rate λ(t) of the part relies on the operation time t is high (shape parameter m>1) in a period when the operation time t is long, and many wear-out failures occur due to the wearing out of the part. In addition, the degree to which the failure rate λ(t) of the part relies on the operation time t is nearly constant (shape parameter m≈1) in a period when the operation time t is neither short nor long, and many random failures occur depending on users' use states and the like.

In this manner, the number of parts that reach their life span and fail increases in a layer for which the operation time t is long. Thus, the types of part related to a malfunction may increase, and parts related to the malfunction may be specified less accurately. Thus, preferably, when the operation time t is classified into layers, the longer the operation time t becomes, the smaller the range is set for a corresponding layer, that is, the range of each of the layers becomes smaller as the operation time t becomes longer.

For example, in a layer for which the mileage corresponding to the operation time t is long, and wear-out failures occur, the shape parameter is m>1. For example, in the case where the mileage is classified into layers at regular intervals when the shape parameter is m=2, the rate of occurrence of a malfunction increases with the square of the mileage. Thus, the failure rates λ(t) for the layers have nearly the same value by reducing the range of each layer of the mileage proportionally to one over the square of a certain value. For example, for layers for a mileage of 6000 km or further in which wear-out failures occur, each of the layers is set to have a range obtained by dividing the previous range by the square of a certain value in the present exemplary embodiment.

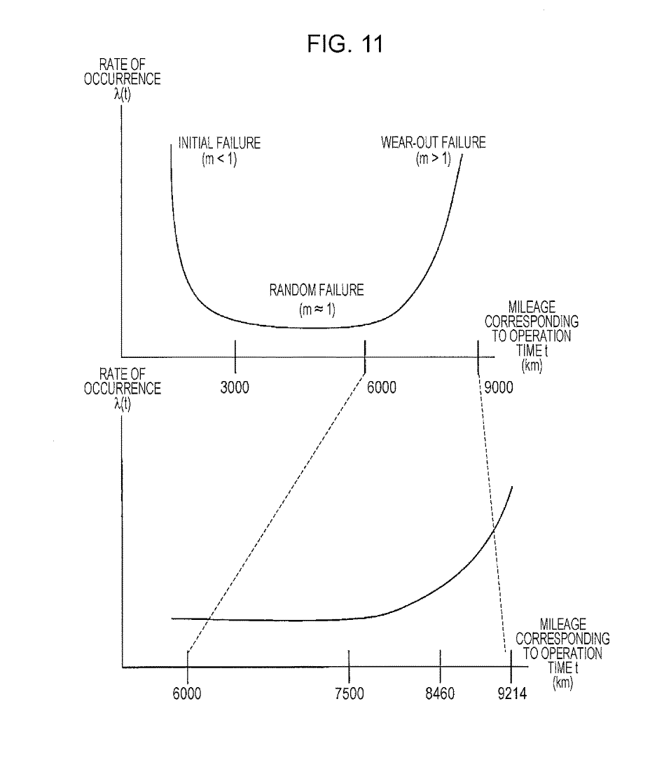

As an example as illustrated in FIG. 11, for example, when the first layer for a mileage of 6000 km or further is set to be a layer of 6000 to 7500 km, the upper limit of the next layer is 7500+(7500-6000)/(7.5/6)²=8460. Likewise, the upper limit of the following layer is 8460+(8460−7500)/(8.46/7.5)²=9214.

When the mileage is classified into layers in this manner, the failure rates λ(t) for the layers fall within a predetermined range, that is, become nearly constant, and the parts related to the malfunction are more accurately specified.

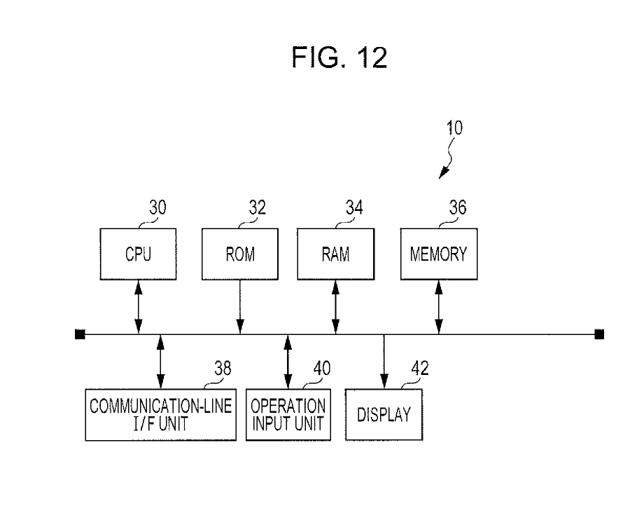

Note that, as illustrated in FIG. 12, the quality management apparatus 10 according to the present exemplary embodiment includes a central processing unit (CPU) 30 that controls the entirety of the apparatus, and processes performed by various units of the quality management apparatus 10 illustrated in FIG. 2 are controlled and executed by the CPU 30. In addition, the quality management apparatus 10 includes a read-only memory (ROM) 32 for storing programs and various types of information used in processing performed by the CPU 30. In addition, the quality management apparatus 10 includes a random-access memory (RAM) 34 for temporarily storing various types of data as a work area for the CPU 30, and a memory 36 for storing various types of information used in processing performed by the CPU 30.

In the present exemplary embodiment, the malfunction-information-and-operation-information memory 12a, the malfunction information memory 12b, the malfunction-related information memory 18, and the manufacturing information memory 26 illustrated in FIG. 2 are provided at a portion of the memory 36; however, the location where these memories are provided are not limited to this. The malfunction information memory 12b, the malfunction-related information memory 18, and the manufacturing information memory 26 may also be provided separately from the memory 36.

Furthermore, the quality management apparatus 10 includes a communication-line interface (I/F) unit 38 for data input-output to an electrically connected external apparatus. In addition, the quality management apparatus 10 includes the operation input unit 40 for receiving an operation input by a user, and a display 42 for displaying data.

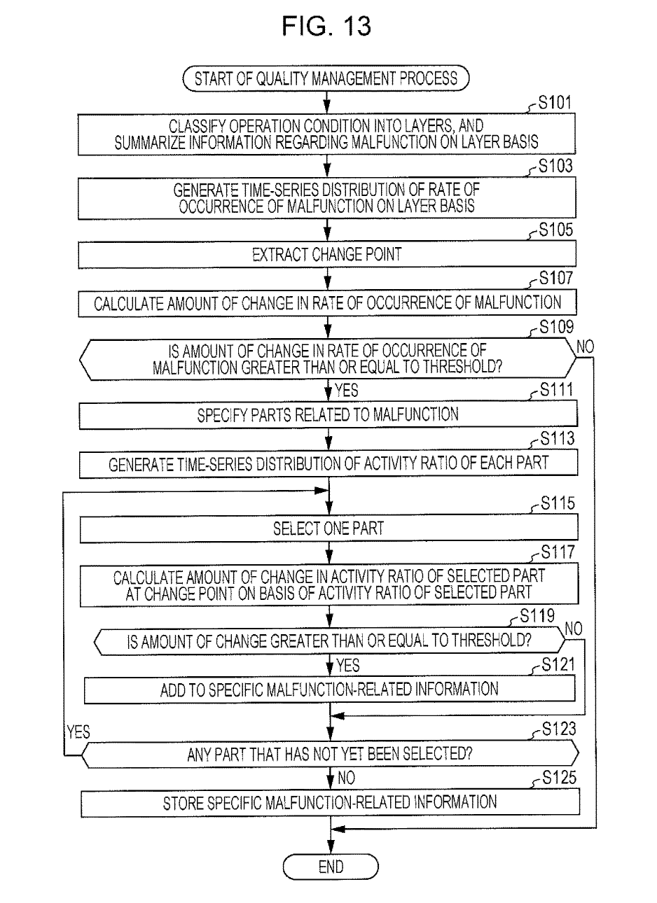

Next, a quality management process executed by the quality management apparatus 10 according to the present exemplary embodiment will be described with reference to the flowchart illustrated in FIG. 13. Note that the case where parts related to a malfunction, which is one type of malfunction here, are specified will be described.

Note that a quality management process program is prestored in the memory 36 in the present exemplary embodiment; however, the location where the program is stored is not limited to this. For example, the quality management process program may also be received from an external device via the communication-line I/F unit 38 and executed. In addition, the quality management process program recorded on a recording medium such as a CD-ROM is read by for example a CD-ROM drive, and the quality management process may also be executed.

The quality management process program is executed when an execution instruction is input by a user operating the operation input unit 40 in the present exemplary embodiment. However, the timing at which the quality management process program is executed is not limited to this, and the quality management process program may also be executed when, for example, new information regarding a malfunction is input to the summarization unit 14. In addition, the quality management process program may also be executed every time a predetermined time (for example, 24 hours) has passed.

In step S101, the summarization unit 14 classifies an operation condition into layers, and summarizes information regarding a malfunction on a layer basis.

In step S103, the time-series distribution generation unit 16 generates a time-series distribution of the rate of occurrence of the malfunction on a layer basis.

In step S105, the change-point extraction unit 20 extracts a change point of the rate of occurrence of the malfunction.

In step S107, the amount-of-change calculation unit 22a calculates the amount of change in the rate of occurrence of the malfunction at the change point.

In step S109, the amount-of-change calculation unit 22a determines whether or not the amount of change in the rate of occurrence of the malfunction is greater than or equal to a predetermined threshold at the change point. In the case where it is determined in step S109 that the amount of change in the rate of occurrence of the malfunction is greater than or equal to the predetermined threshold at the change point (Yes in S109), the process proceeds to step S111. In the case where it is determined in step S109 that the amount of change in the rate of occurrence of the malfunction is not greater than or equal to the predetermined threshold at the change point (No in S109), execution of the present quality management process program ends. In this manner, the case where a process for specifying parts related to the malfunction is performed when the amount of change in the rate of occurrence of the malfunction is greater than or equal to the predetermined is described in order to avoid execution of unnecessary processing in the present exemplary embodiment; however, there may be other cases. That is, even in the case where the amount of change in the rate of occurrence of the malfunction is less than the predetermined threshold, parts related to the malfunction may also be specified.

In step S111, the amount-of-change calculation unit 22a specifies parts related to the malfunction.

In step S113, the amount-of-change calculation unit 22a generates, for each part, a time-series distribution diagram of the activity ratio of the part related to the malfunction.

In step S115, the amount-of-change calculation unit 22a selects a part from among the parts related to the malfunction.

In step S117, the amount-of-change calculation unit 22a calculates, on the basis of the activity ratio of the selected part, the amount of change in the activity ratio of the part at the change point of the rate of occurrence of the malfunction.

In step S119, the malfunction-related information generation unit 22b determines whether or not the amount of change in the activity ratio of the part is greater than or equal to a predetermined threshold at the change point of the rate of occurrence of the malfunction. In the case where it is determined in step S119 that the amount of change in the activity ratio of the part is greater than or equal to the predetermined threshold at the change point of the rate of occurrence of the malfunction (Yes in S119), the process proceeds to step S121. In the case where it is determined in step S119 that the amount of change in the activity ratio of the part is less than the predetermined threshold at the change point of the rate of occurrence of the malfunction (No in S119), the process proceeds to step S123.

In step S121, the malfunction-related information generation unit 22b adds, to specific malfunction-related information, the part selected in step S115 and the amount of change in the activity ratio of the part. Note that in the case where the specific malfunction-related information has not yet been generated, specific malfunction-related information is generated in which information regarding the part selected in step S115, information regarding the change point of the rate of occurrence of the malfunction, and information regarding the amount of change in the activity ratio of the part are associated with each other.

In step S123, the malfunction-related information generation unit 22b determines whether or not there is any part that has not yet been selected in step S115. In the case where it is determined in step S123 that there is a part that has not yet been selected (Yes in S123), the process proceeds to step S115. In the case where it is determined in step S123 that there is no part that has not yet been selected (No in S123), the process proceeds to step S125.

In step S125, the malfunction-related information generation unit 22b stores, in the malfunction-related information memory 18, the specific malfunction-related information, and execution of the present quality management process program ends. Note that in the case where the specific malfunction-related information has not yet been generated, execution of the present quality management process program ends without storing specific malfunction-related information in the malfunction-related information memory 18.

Note that, in the present exemplary embodiment, the case where the products to be managed on the market are the vehicles 6, and information regarding a malfunction is classified into layers on a mileage basis using the mileage of the vehicles 6 as an operation condition has been described; however, the products to be managed are not limited to the vehicles 6. The products on the market may also be any type of conveyance. In addition, for example, the products on the market are image forming apparatuses forming images on paper sheets using toner, and an operation condition may be a time elapsed from the start of operation, the total number of paper sheets on which images are formed, the total amount of toner consumed, or the like. In addition, the products to be managed on the market may also be electronic devices such as personal computers and portable terminals, and in this case, an operation condition may be an operation time, or the highest temperature or average temperature of the products.

Alternatively, information regarding a malfunction may also be classified into layers in accordance with at least one of an operation time and a mileage from a new car, the number of times of an operation that may deteriorate the new car when the operation is performed repeatedly, and the like, and summarized. Note that examples of the number of times of an operation that may deteriorate the new car when the operation is performed repeatedly include the number of times the engine is switched on and off, the total number of times the brake pedal is pressed, and the total number of times the gear is shifted using the shift lever.

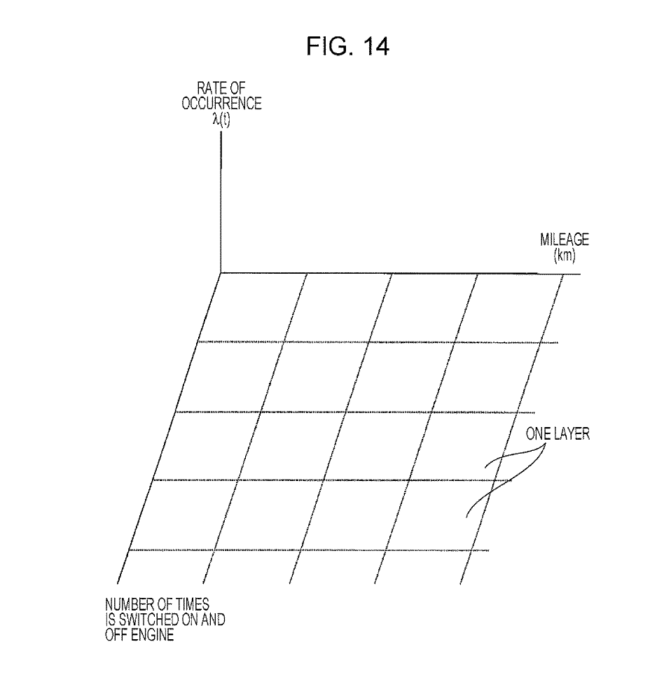

In addition, the number of types of operation condition related to a malfunction occurring in the vehicles is not limited to one, and a malfunction may occur due to multiple types of operation conditions. In that case, it becomes difficult to specify a manufacturing condition related to the malfunction. In that case, preferably, parts related to the malfunction are specified by classifying the rate of occurrence of the malfunction into layers multidimensionally by taking multiple operation conditions into account. Note that in the case where classification into layers is performed multidimensionally by taking multiple operation conditions into consideration, for example, preferably, the rate of occurrence of the malfunction is classified into layers under an operation condition of the vehicles for each type of operation condition, and for combinations of layers, the combinations differing from each other and each including multiple types of operation condition, a relationship between the rate of occurrence of the malfunction and a manufacturing condition of the products is extracted for each combination. As an example as illustrated in FIG. 14, parts related to the malfunction may be more accurately specified by classifying the rate of occurrence of the malfunction into layers two-dimensionally under two types of operation condition, the mileage and the number of times the engine is switched on and off.

In addition, the case where the rate of occurrence of the malfunction is classified into layers under the operation condition, and a time-series distribution of the rate of occurrence of the malfunction is generated on a layer basis, a change point is extracted, and the amount of change regarding the manufacturing condition (the activity ratio of a part) is calculated at the change point has been described in the present exemplary embodiment; however, there may be other cases. For example, the manufacturing condition (the activity ratio of a part) is also classified into layers under the operation condition, a time-series distribution is generated on a layer basis, using the time-series distributions of the rate of occurrence of the malfunction classified into layers and the time-series distributions of the manufacturing condition classified into the layers, a manufacturing condition related to the malfunction may also be specified.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A quality management apparatus comprising:
an acquisition unit that acquires, about products to be managed, a rate of occurrence of a malfunction on an occurrence period basis, an operation condition of the products, and a manufacturing condition for the products; and
an extraction unit that classifies the rate of occurrence into layers under the operation condition, and extracts, for each layer under the operation condition, a relationship between the rate of occurrence and the manufacturing condition.

2. The quality management apparatus according to claim 1, wherein
the acquisition unit acquires the rate of occurrence of the malfunction on the occurrence period basis and on a malfunction type basis, and
the extraction unit classifies the rate of occurrence into the layers under the operation condition, and extracts, for each layer under the operation condition, a relationship between the rate of occurrence and the manufacturing condition on the malfunction type basis.

3. The quality management apparatus according to claim 1,
wherein the rate of occurrence is a ratio of the number of products in which the malfunction has occurred to the number of products that are operating.

4. The quality management apparatus according to claim 2,
wherein the rate of occurrence is a ratio of the number of products in which the malfunction has occurred to the number of products that are operating.

5. The quality management apparatus according to claim 1,
wherein the extraction unit extracts, for each layer under the operation condition, a relationship between the rate of occurrence and the ratio of the number of products including a part manufactured under a predetermined manufacturing condition to the number of products in which the malfunction has occurred.

6. The quality management apparatus according to claim 2,
wherein the extraction unit extracts, for each layer under the operation condition, a relationship between the rate of occurrence and the ratio of the number of products including a part manufactured under a predetermined manufacturing condition to the number of products in which the malfunction has occurred.

7. The quality management apparatus according to claim 3,
wherein the extraction unit extracts, for each layer under the operation condition, a relationship between the rate of occurrence and the ratio of the number of products including a part manufactured under a predetermined manufacturing condition to the number of products in which the malfunction has occurred.

8. The quality management apparatus according to claim 4,
wherein the extraction unit extracts, for each layer under the operation condition, a relationship between the rate of occurrence and the ratio of the number of products including a part manufactured under a predetermined manufacturing condition to the number of products in which the malfunction has occurred.

9. The quality management apparatus according to claim 5, wherein
the operation condition is an operation time of the products, and
the extraction unit classifies, into layers each having a smaller range than those for the other range of the operation time, a certain range of the operation time including a period in which the rate of occurrence under the operation condition is greater than or equal to a predetermined threshold.

10. The quality management apparatus according to claim 6, wherein
the operation condition is an operation time of the products, and
the extraction unit classifies, into layers each having a smaller range than those for the other range of the operation time, a certain range of the operation time including a period in which the rate of occurrence under the operation condition is greater than or equal to a predetermined threshold.

11. The quality management apparatus according to claim 5, wherein
the products are vehicles,
the operation condition is a mileage of the vehicles, and
the extraction unit classifies, into layers each having a smaller range than those for the other range of the mileage, a certain range of the mileage in which the mileage of the vehicles is greater than or equal to a predetermined threshold.

12. The quality management apparatus according to claim 6, wherein
the products are vehicles,
the operation condition is a mileage of the vehicles, and
the extraction unit classifies, into layers each having a smaller range than those for the other range of the mileage, a certain range of the mileage in which the mileage of the vehicles is greater than or equal to a predetermined threshold.

13. The quality management apparatus according to claim 5, wherein
the products are electronic devices,
the operation condition is an operation time of the electronic devices, and
the extraction unit classifies, into layers each having a smaller range than those for the other range of the operation time, a certain range of the operation time in which the operation time of the electronic devices is greater than or equal to a predetermined threshold.

14. The quality management apparatus according to claim 6, wherein
the products are electronic devices,
the operation condition is an operation time of the electronic devices, and
the extraction unit classifies, into layers each having a smaller range than those for the other range of the operation time, a certain range of the operation time in which the operation time of the electronic devices is greater than or equal to a predetermined threshold.

15. The quality management apparatus according to claim 1, wherein
the extraction unit determines the range of each layer under the operation condition such that the rate of occurrence for each layer under the operation condition falls within a predetermined range.

16. The quality management apparatus according to claim 1, wherein
the extraction unit extracts, in a case where an amount of change in the rate of occurrence on a time-series basis becomes greater than or equal to a predetermined first threshold, and an amount of change under the manufacturing condition becomes greater than or equal to a predetermined second threshold within a predetermined time, the manufacturing condition as a manufacturing condition related to the malfunction of the products.

17. The quality management apparatus according to claim 1, wherein
the operation condition is included in a plurality of types of operation condition of the products, and
the extraction unit classifies, for each type of operation condition, the rate of occurrence into layers under the operation condition, and for combinations of layers, the combinations differing from each other and each including a plurality of types of operation condition, the extraction unit extracts, for each combination, a relationship between the rate of occurrence of the malfunction and the manufacturing condition.

18. The quality management apparatus according to claim 1, wherein
the manufacturing condition includes at least one of manufacturing conditions of parts constituting the products, a company that manufactures the products, manufacturing lines for manufacturing the products, and workers manufacturing the products.

19. A quality management method comprising:
acquiring, about products to be managed, a rate of occurrence of a malfunction on an occurrence period basis, an operation condition of the products, and a manufacturing condition for the products; and
classifying the rate of occurrence into layers under the operation condition, and extracting, for each layer under the operation condition, a relationship between the rate of occurrence and the manufacturing condition.

20. A non-transitory computer readable medium storing a program causing a computer to execute a process, the process comprising:
acquiring, about products to be managed, a rate of occurrence of a malfunction on an occurrence period basis, an operation condition of the products, and a manufacturing condition for the products; and
classifying the rate of occurrence into layers under the operation condition, and extracting, for each layer under the operation condition, a relationship between the rate of occurrence and the manufacturing condition.
